(19) United States
(12) Patent Application Publication
(10) Pub. No.: US 2009/0027194 A1
(43) Pub. Date: Jan. 29, 2009

(54) DOOR LOCKING/UNLOCKING UNIT

(76) Inventor: Leigh Jason McGrath, Victoria (AU)

Correspondence Address: EDWIN D. SCHINDLER, FIVE HIRSCH AVENUE, P.O. BOX 966, CORAM, NY, 11727-0966, US

(21) Appl. No.: 12/280,405

(22) PCT Filed: Feb. 26, 2007
(86) PCT No.: PCT/AU07/00204

§ 371 Date: Aug. 22, 2008

(30) Foreign Application Priority Data
Feb. 24, 2006 (AU) 2006900922

(51) Int. Cl. G08B 21/00; G05B 19/00; G06K 9/00

(52) U.S. Cl. 340/540; 340/5.7; 340/5.64; 340/5.51; 340/5.6; 340/5.53

(57) ABSTRACT

A door locking/unlocking apparatus includes a housing, a locking mechanism, at least one control device for controlling the locking mechanism and at least one sensory device, so that the door locking/unlocking apparatus enables a door controlled by the apparatus to be automatically unlocked upon the detection or presence of smoke or fire.

### FIELD OF THE INVENTION

The invention relates to a door locks, and in particular, to a door locking/unlocking unit which incorporates a smoke and/or fire activated unlocking means which enables the door to be automatically unlocked upon the detection, and/or in the presence, of smoke and/or a fire.

### BACKGROUND

Many locking systems coupled to doorways have a lock mechanism which is used by occupants to secure their premises, and the lock can be unlocked, locked and/or deadlocked from either side of the doorway. In the tragic event of a fire, the occupants usually only have a few minutes before they are overcome by smoke or heat. Locking arrangements that encompass internal unlocking latches may not give a person escaping from a building sufficient time before they are overcome with smoke or heat. Furthermore in the case of children or individuals who are unaware of the operation of the locking mechanism, or are unable to unlock the lock mechanism, where there is a deterioration of visibility due to the density of smoke, internal locks form an additional hazard.

Even worse, if the door has been deadlocked by another person who has left the building with the key or the hand-held control device, then any occupants inside are left unable to unlock the door and are consequently trapped. Tragically, these circumstances lead to a significant number of deaths every year.

Accordingly, it is an object of the present invention to provide a door locking/unlocking unit which provides a smoke and/or fire activated unlocking means which enables the door to be automatically unlocked upon the detection, and/or in the presence, of smoke and/or a fire.

### SUMMARY OF THE INVENTION

The present invention provides a door locking/unlocking unit including:

a housing;
a locking mechanism;
at least one control means to control the locking mechanism; and
at least one sensory device whereby the door locking/unlocking unit enables the door to be automatically unlocked upon the detection, and/or in the presence, of smoke and/or a fire.

The door is preferably an entrance/exit door, garage door, roller door, cupboard, gate, or the like.

The locking mechanism preferably has a locking member located within a lock body. The locking member is in the form of a latch for securing a door, said locking member having locked and unlocked modes. The locking mechanism also includes an actuator for controlling the locking member. The actuator preferably includes a solenoid or the like which is adapted to control a spindle connected to the latch in order to provide movement for the latch.

In a first aspect of the invention the control means is preferably a wireless remote which is adapted to transmit a wireless signal which is a security coded and/or an encrypted signal such as a hopping or rolling code to ensure that the door locking/unlocking unit is secure. The remote may have provided a receiver controller chip having a memory location which is adapted to hold a specific code programmed thereon and receive said specific code from a wireless remote transmitter so that, upon receipt of a correct code, the receiver controller chip will activate the actuator of the locking mechanism to release the locking member.

In a second aspect of the invention, the control means is a keypad which is adapted to release the latch when a correct code in entered into said keypad.

In a third aspect of the invention, the control means is an access card/fob. The unit may have provided a magnetic card reader which is adapted to read an access code of the access card/fob in order to release the lock member of the door locking/unlocking unit which can be a latch or electric or magnet strike or lock member.

In a fourth aspect of the invention, the control means is a fingerprint reader/biometric scanner and/or code input means which is adapted to read a person's fingerprint or scan a person's iris or the like in order to verify the person and allow access to the door.

The control means may preferably be a key which is adapted to control the actuator directly and can be provided alone or as a secondary control unit to function as a master override mechanism in the event of failure of the other electronic systems.

A first sensory device is preferably a smoke sensor which is adapted to detect the presence of smoke within the house. A second sensory device is preferably a heat sensor which is adapted to detect excessive heat or an abnormal rise in temperature within the house. The sensory device may be integrated with the unit or provided as a stand-alone unit to allow easy installation to a door, or in very close proximity to either the locking/unlocking unit, or the door.

The unit may be powered by an internal power source such as a battery or the like which is provided in addition to, or instead of, a mains power supply. The unit may preferably have provided a jack which is adapted to enable a battery to be connected thereto in the event of a power failure.

The unit preferably has provided an alarm which is adapted to be activated if any of the components of the door locking/unlocking unit become compromised in their ability to function and/or the unit is tampered within. The alarm is either in the form of an audible sound or visible indicator such as a flashing light, or a combination of these.

Preferably, the unit has at least one indicator which is adapted to indicate the unlocked and locked modes of the locking mechanism to a person. The indicator is preferably a coloured LED light.

In order that the invention may be more readily understood we will describe by way of non-limiting examples of specific embodiments thereof.

### BRIEF DESCRIPTION OF THE DRAWING FIGURES

FIG. 1 shows a front view of the door locking/unlocking unit according to a preferred embodiment of the invention.

FIG. 2 shows a front view of the door locking/unlocking unit according to a preferred embodiment of the invention whereby the control means is in the form of a fingerprint reader/code input means.

FIG. 3 shows a front view of the door locking/unlocking unit according to a preferred embodiment of the invention whereby the control means is in the form of a fingerprint reader/code input means.

FIG. 4 shows a back view of the door locking/unlocking unit according to a preferred embodiment of the invention.

FIG. 5 shows a side view of the door locking/unlocking unit according to a preferred embodiment of the invention.

FIG. 6 shows an exploded perspective view of the door locking/unlocking unit according to a preferred embodiment of the invention whereby the control means is in the form of a fingerprint reader/code input means.

FIG. 7 shows a front view of the door locking/unlocking unit according to a preferred embodiment of the invention whereby the control means is in the form of a keypad.

FIG. 8 shows an exploded perspective view of the door locking/unlocking unit according to a preferred embodiment of the invention whereby the control means is in the form of a keypad.

FIG. 9 shows an exploded perspective view of the door locking/unlocking unit according to a preferred embodiment of the invention whereby the control means is in the form of an access card/fob.

FIG. 10 shows a back view of the front portion of the door locking/unlocking unit according to a preferred embodiment of the invention.

FIG. 11 shows a perspective view of the internal components within the front portion of the door locking/unlocking unit according to a preferred embodiment of the invention.

### DESCRIPTION OF A PREFERRED EMBODIMENT OF THE INVENTION

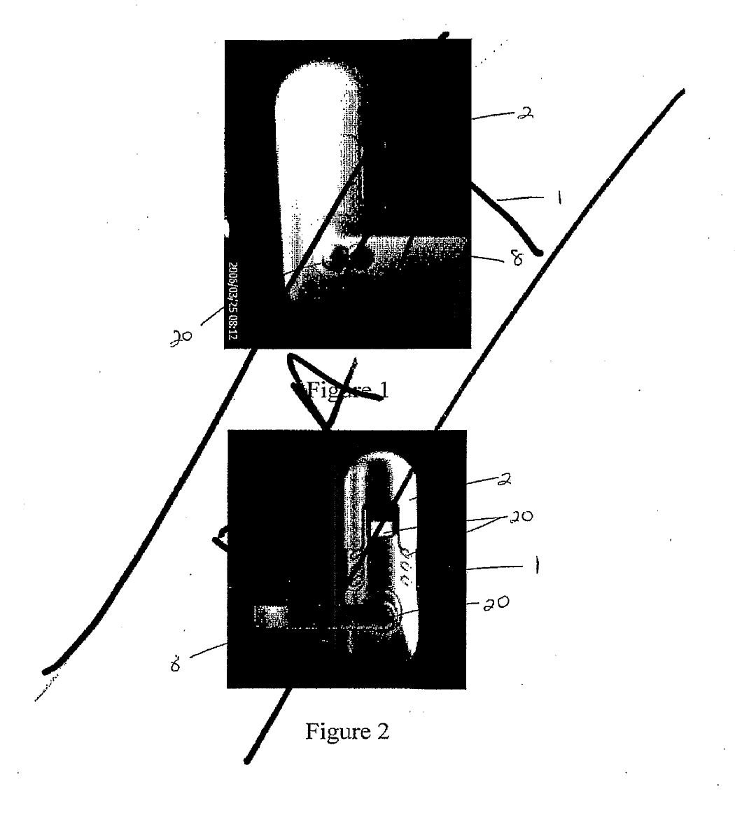

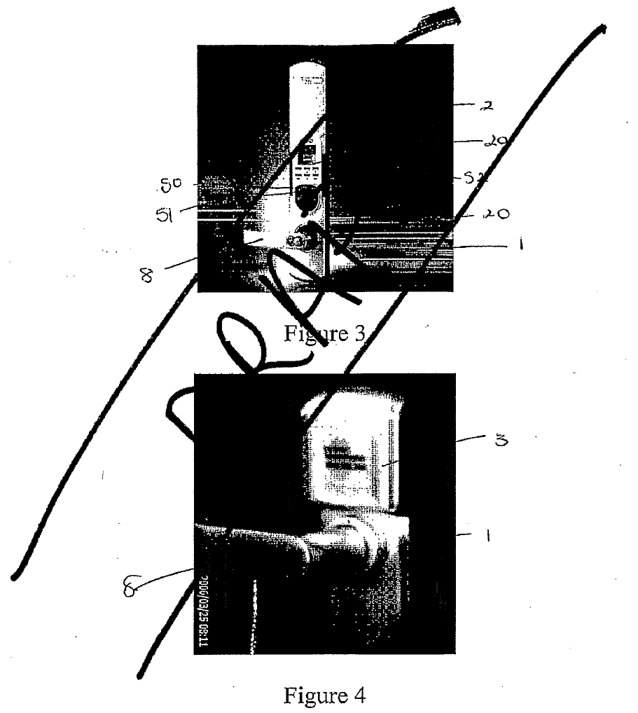

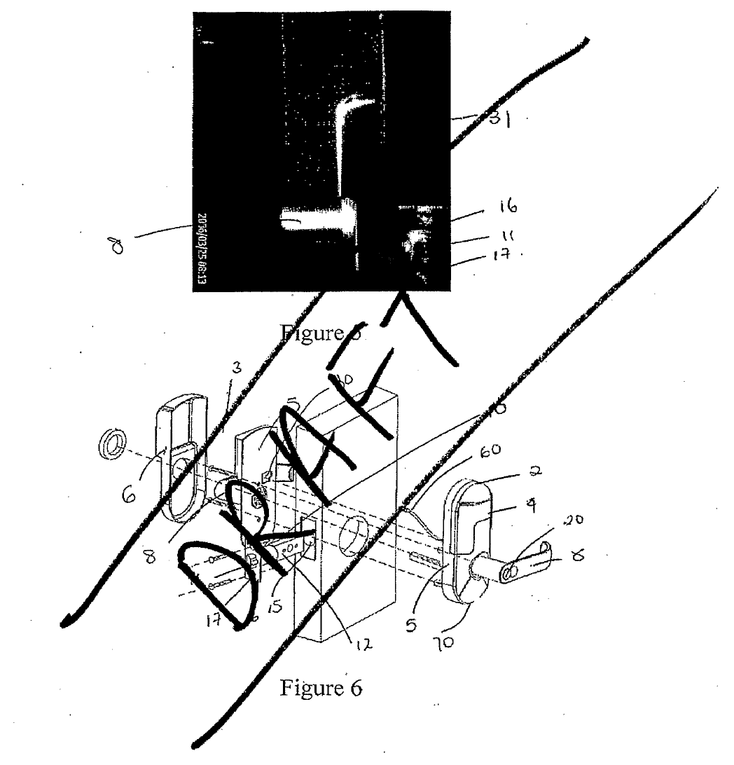

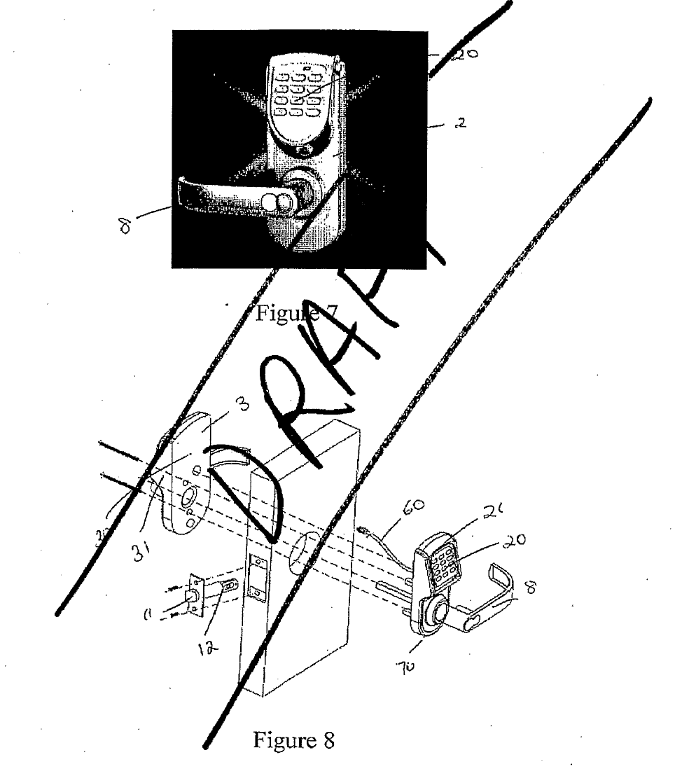

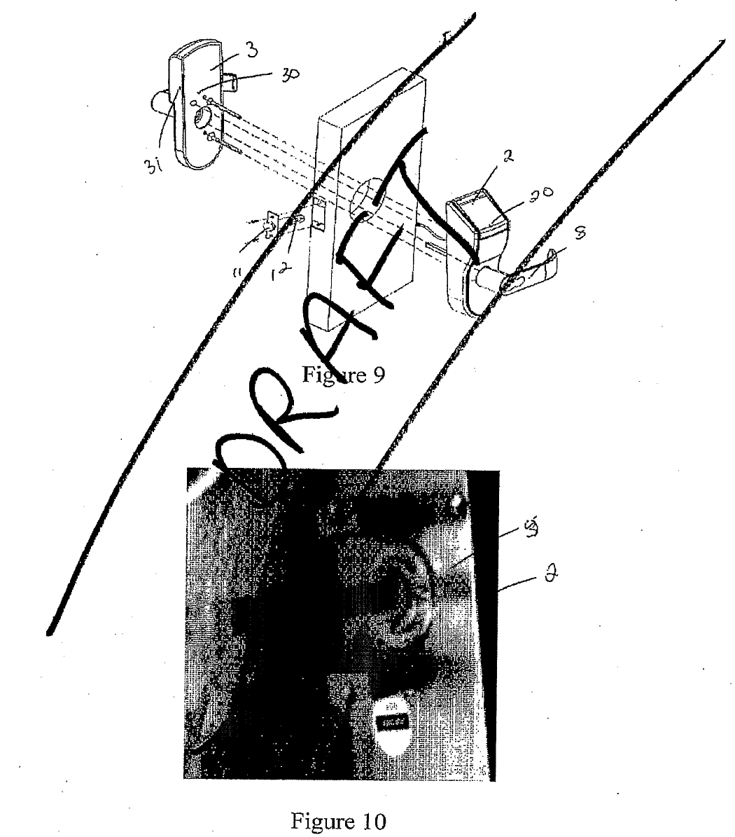

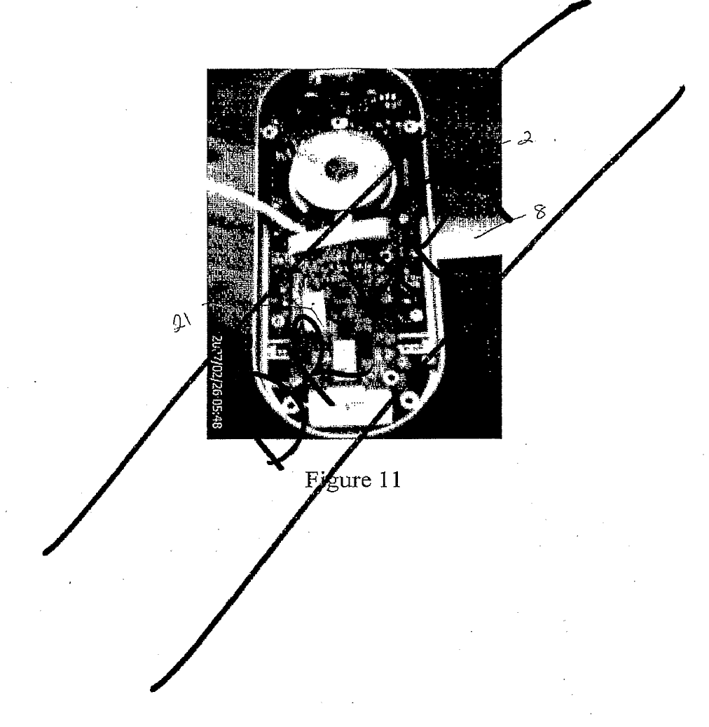

FIGS. 1 to 11 show the door locking/unlocking unit according to preferred embodiments of the invention.

In this preferred embodiment, the invention provides a door locking/unlocking unit 1 which provides a smoke and/or fire activated unlocking means which enables the door to be automatically unlocked upon the detection, and/or in the presence, of smoke and/or a fire. The locking/unlocking unit 1 shall be described herein in terms of a locking/unlocking unit for a standard front or rear door of a dwelling or building. However, it is envisaged that the type of door may also preferably include, but not be limited to, any type of door for a room or building, garage door, roller door, cupboard, gate, or any other suitable door. The door locking/unlocking unit 1 is preferably made of a metal material. However, it is envisaged that any other suitable material may also be adopted so long as it is durable, fire-resistant, water-resistant and meets the requirements of the invention. It is envisaged that the shape, style and dimensions of the locking/unlocking unit 1 and/or its components may be varied as desired to suit different doors and/or applications.

The housing of the unit 1 is preferably divided into two portions, a front portion 2 and a back portion 3. The front portion 2 is preferably adapted to be secured to the front of the door facing the outside of the dwelling or building. The back portion 3 is adapted to be secured to the back of the door facing the inside of a dwelling or building. The front portion 2 and back portion 3 comprise an outer cover 4,6 and a backing plate 5,7. The outer covers 4,6 and backing plates 5,7 preferably have provided a complimentary rim portion (not shown) along their outer edge so that the outer covers 4,6 and respective backing plates 5,7 can be fitted together in a snap-fit configuration. The front portion 2 and back portion 3 preferably has provided an aperture which is adapted to receive a handle member 9 connected thereto. The front portion 2 preferably has provided a wire 60 which is adapted to connect the components within the front portion 2 to the components and/or power supply within the back portion 3.

The door locking/unlocking unit 1 includes a locking mechanism 10. The locking mechanism 10 preferably has a locking member 11 located within a lock body 18 which is adapted to hold the door is a closed position. The locking member 11 is preferably a latch. However, it is envisaged that the locking member 11 could also be a bolt, magnetic device, electric strike, automotive locking device, or any other suitable locking means. In an alternate embodiment, it is envisaged that the door locking/unlocking unit 1 may be used with a preexisting locking member on a door. In a further embodiment, a second locking member may be provided in the form of a dead-bolt to provide double security for the door locking/unlocking unit. In operation, the latch 11 is adapted to line up with a strike (not shown) provided in a door frame. When the door is locked or a door handle/knob 8 is moved the latch 11 will extend or retract from the strike to lock or release the door. The notch is generally surrounded by a strike plate which may be supplied separately or together with the door locking/unlocking unit 1.

Preferably the locked mode is characterized by extension of the latch 11 through a cavity 15 a strike plate 16 provided on a door to which the door locking/unlocking unit is attached. To install the strike plate 16, a cavity 15 is drilled out of the side wall of the door, so that it corresponds with a complimentary cavity provided on an adjacent door frame, and the strike plate 16 is fitted within the cavity. The strike plate 16 has at least one aperture so that the strike plate 16 can be secured to the door using a suitable securing means such as a screw or the like. The strike plate also has provided a central aperture 17 for receiving the latch 11 therethrough.

The locking mechanism 10 has an actuator 12 which is adapted to control the movement and mode of the locking member 11 from an unlocked positioned to a locked position and vice versa. The actuator 12 preferably includes a solenoid or the like which is adapted to control a spindle connected to the latch in order to provide movement for the latch 11. When the key is turned and/or the actuator 12 is activated, the spindle moves the latch 11 to release the door. It is preferred that the locking mechanism 10 provides the door locking/unlocking unit 1 with locked, deadlocked and unlocked locking modes. It is envisaged that any other suitable locking mechanism with the same or different components may also be adopted.

The door locking/unlocking unit 1 preferably has provided at least one control means 20 which is adapted to control the actuator 12 of locking mechanism 10 in order to engage different locking modes. The control unit 20 is preferably adapted to transmit instructions in order for the door to switch between locked, unlocked and/or deadlocked modes and can preferably include, but not be limited to, one or more of the following:
a wireless remote;
a keypad;
an access card;
a programmable chip; and/or
a key wherein the key controls the actuator 12 directly and can be provided alone or as a secondary control unit to function as a master override mechanism in the event of failure of the other electronic systems.

In a first aspect of the invention, the control means 20 is preferably in the form of a wireless remote. The wireless remote 20 is preferably adapted to transmit signals to the door locking/unlocking unit 1 via infrared, radio frequency, Bluetooth, Wi-Fi or any other suitable wireless technology/transmission means. The wireless signal is a security coded and/or an encrypted signal such as a hopping or rolling code to ensure that the door locking/unlocking unit is secure. In this aspect, the door locking/unlocking unit preferably has provided a receiver controller chip 21/programmable chip having a memory location which is adapted to hold a specific code programmed thereon. Preferably, the receiver controller chip 21 can be programmed or re-programmed to communicate with new security, encryption and/or function codes to control the various actions, thereby preserving the secure nature of the door locking/unlocking system. When the receiver controller chip 21 receives the desired code it will activate the actuator 12 to release the latch 11. It is envisaged that the receiver 21 may operate to control the actuator 12 by controlling movement of the spindle to drive the latch 11.

Ordinarily the remote wireless device 20 allows the operator to control the latch 11 in any one of three modes or positions being, locked, unlocked and deadlocked. The “deadlocked mode” requires a key or remote for the door to be unlocked. In contrast, the “unlocked mode” is where the door is locked however, an operator does not require a key or wireless remote to unlock the door from the inside of the building. For “locked mode” an operator can unlock a locked door by for example, depressing an “unlock button” on the remote, or door or door locking/unlocking unit on the interior of the dwelling or building.

In a second aspect of the invention, the control means 20 is in the form of a keypad. The keypad 20 is adapted to be fitted on the upper half of the front portion 2 of the door locking/unlocking unit 1. When a correct code is entered into the keypad, the actuator 12 relay will release the latch 11. The latch 11 can either remain in place until the code is entered again, or automatically spring back into a closed position. In a further embodiment of the invention, the keypad 20 may be adapted to control an electric or magnetic strike or lock member.

In a third aspect of the invention, the control means is in the form of an access card/fob. In this aspect, the front portion 2 of the door locking/unlocking unit 1 is provided with a magnetic card reader which is adapted to read as access code on the access card in order the control release the lock member 11 of the door locking/unlocking unit 1 which may be a latch or electric or magnet strike or lock member.

In a fourth aspect of the invention, the control means is in the form of a fingerprint reader/biometric scanner which is adapted to read a person's fingerprint by extracting the energy emitted by the body or scan a person's iris or the like in order to determine the correct identity of an authorised person prior to unlocking the door. The control means may further include a code input means which allows a user to further enter a correct code in the event that someone has copied a person's fingerprint or bypassed the system in another alternate manner.

The door locking/unlocking unit 1 has at least one sensory device 30. The sensory device(s) is/are adapted to be positioned within the back portion 3 of the door locking/unlocking unit 1 so that it can detect something within the interior of the dwelling or building such as the presence of smoke and/or excessive heat. Accordingly, the back portion 3 of the door locking/unlocking unit 1 may have provided at least one aperture 31 which is designed to assist in the detection by providing an open path to the sensory device 30. A first sensory device is preferably a smoke sensor which is adapted to detect the presence of smoke within the house. A second sensory device 30 is preferably a heat sensor which is adapted to detect excessive heat or an abnormal rise in temperature within the house. In an alternate embodiment, it is envisaged that the sensory device 30 may be provided in a stand-alone unit to allow easy installation to a door and/or could be supplied separately for installation on, within, or in very close proximity to either the locking/unlocking unit, or the door. Additional smoke and/or heat sensors positioned further away from the door within the house may be linked to the unit 1 to allow the earlier detection of the smoke and/or fire, However, this is not preferred as it may lead to the unwanted unlocking of the door as a result of cooking smoke or the like.

In the event of a fire, smoke or heat will activate the sensory device 30 through the openings 31 in the back portion 3 of the housing. The sensory device 30 may have provided a transmitter (not shown) to send a signal to the receiver controller chip 21 in order to activate the actuator 12 or lock latch driving mechanism to withdraw the latch 11 from the strike plate, thereby unlocking the door. This will allow the occupants of the building to escape through the unlocked door without having to worry about finding a key or other control unit 20 to unlock the door.

The door locking/unlocking unit 1 is preferably powered by an internal power source such as a battery (not shown) to avoid the door locking/unlocking unit 1 not functioning if a mains power supply fails (for example by severing of a wire or by lack of mains power). However, the unit 1 could also be powered externally, for example through mains power supply in addition to and/or instead of the internal battery. The unit preferably has provided a jack 70. The jack is preferably a 9 volt jack which enables a 9 volt battery to be connected thereto in order to power the system in the event of a power failure.

The door locking/unlocking unit 1 has provided an alarm 40. If any of the components of the door locking/unlocking unit 1 become compromised in their ability to function, the alarm 40 will be activated within the unit 1 and a signal may be transmitted to a remote alarm 40. Preferably said alarm 40 is in the form of an audible sound or a visible indicator such as a flashing light, or a combination of these. The alarm may also be in the form of a message sent to notify a person via sms, mms, email or any other suitable instant communication means. In one example where the integrity of the door locking/unlocking unit 1 becomes compromised, for example by tampering, there could be a signal that is constantly passed through each component of the door locking/unlocking unit 1 and then fed to an alarm device 40 and/or an alarm activating device (not shown). When the electrical signal stops, the alarm device can activate to beep or flash either locally, or to transmit a signal to a remote location to indicate that the unit no longer functions. In the event that door locking/unlocking unit 1 is tampered with and the link between any one of the features is broken, the alarm device 40 and/or the alarm activating device will be activated. In an alternate embodiment of the invention, it is envisaged that the alarm activation device may be in the form of a motion sensor which can be activated to trigger the alarm 40 when the housing of the unit has been broken or moved.

The door locking/unlocking unit 1 preferably has at least one indicator 50 which is adapted to indicate the unlocked and locked modes of the locking mechanism 10 to a person. The indicator 50 is preferably a coloured LED or any other suitable light. It is envisaged that a green LED 51 will indicate that the door locking/unlocking unit 1 is in an unlocked mode, and a red LED 52 will indicate that the door locking/unlocking unit 1 is in a locked mode.

In an alternate embodiment, there may be additional LED indicators including an LED which illuminates green when the battery is charged, and a red LED to indicate that the battery requires replacement. A periodic beeping alarm can also be included to activate when the replacement of the battery is required. This alarm can be the same alarm that indicates when the system is not functioning correctly, for example in the case of tampering.

While we have described herein a particular embodiment of a door locking/unlocking unit, it is further envisaged that other embodiments of the invention could exhibit any number and combination of any one of the features previously described. However, it is to be understood that any variations and modifications can be made without departing from the spirit and scope thereof.

1-24. (canceled)

25. A door locking/unlocking apparatus for a door, comprising:
a locking mechanism for locking and unlocking a door;
means for controlling said locking mechanism for locking and unlocking the door; and,
a sensor for sensing a presence of smoke or fire, said sensor actuating said means for controlling said locking mechanism so that said locking mechanism unlocks the door upon detection of the presence of smoke or fire.

26. The door locking/unlocking apparatus for a door according to claim 25, wherein said locking mechanism includes a latch and said means for controlling said locking mechanism for locking and unlocking the door includes an actuator having a solenoid for controlling a spindle connected to said latch of said locking mechanism for providing movement for said latch.

27. The door locking/unlocking apparatus for a door according to claim 25, wherein said means for controlling said locking mechanism for locking and unlocking the door is a wireless control device and transmits a wireless signal.

28. The door locking/unlocking apparatus for a door according to claim 27, wherein said wireless control device includes means for transmitting said wireless signal that includes a security code for unlocking the door.

29. The door locking/unlocking apparatus for a door according to claim 27, wherein said wireless control device includes means for transmitting said wireless signal that includes an encrypted signal for unlocking the door.

30. The door locking/unlocking apparatus for a door according to claim 29, wherein said encrypted signal for unlocking the door includes a hopping or rolling code.

31. The door locking/unlocking apparatus for a door according to claim 27, wherein said locking mechanism includes a receiver control chip for receiving said wireless signal transmitted by said means for controlling said locking mechanism for locking and unlocking the door.

32. The door locking/unlocking apparatus for a door according to claim 31, wherein said receiver control chip for receiving said wireless signal includes a memory location for holding a specific code that is transmitted as part of said wireless signal for unlocking the door when the specific code is received by said receiver control chip.

33. The door locking/unlocking apparatus for a door according to claim 25, wherein said means for controlling said locking mechanism for locking and unlocking the door includes a keypad for controlling said locking mechanism to lock or unlock the door.

33. The door locking/unlocking apparatus for a door according to claim 25, wherein said means for controlling said locking mechanism for locking and unlocking the door includes an access card/fob for controlling said locking mechanism to lock or unlock the door.

34. The door locking/unlocking apparatus for a door according to claim 33, wherein said means for controlling said locking mechanism includes a magnetic card reader for reading an access code of said access card/fob for controlling said locking mechanism to lock or unlock the door.

35. The door locking/unlocking apparatus for a door according to claim 25, wherein said means for controlling said locking mechanism for locking and unlocking the door includes a biometric scanner for reading an identifiable biological feature of a person for controlling said locking mechanism to lock or unlock the door.

36. The door locking/unlocking apparatus for a door according to claim 35, wherein the identifiable biological feature of the person scanned is a fingerprint of the person.

37. The door locking/unlocking apparatus for a door according to claim 35, wherein the identifiable biological feature of the person scanned is an iris of an eye of the person.

38. The door locking/unlocking apparatus for a door according to claim 25, further comprising a heat sensor for sensing an abnormal rise in temperature within a designated area.

39. The door locking/unlocking apparatus for a door according to claim 25, further comprising an alarm for altering of any tampering of said door locking/unlocking apparatus.

40. The door locking/unlocking apparatus for a door according to claim 39, wherein said alarm for altering of any tampering of said door locking/unlocking apparatus includes an audible alarm.

41. The door locking/unlocking apparatus for a door according to claim 39, wherein said alarm for altering of any tampering of said door locking/unlocking apparatus includes a visual alarm.
